(19) United States
(12) Patent Application Publication
(10) Pub. No.: US 2017/0323734 A1
(43) Pub. Date: Nov. 9, 2017

(54) PHOTOELECTROCHEMICAL CELL AND PROCESS FOR THE PRODUCTION OF SAID CELL

(71) Applicant: NISHATI S.R.L., Ala (TN) (IT)

(72) Inventor: Giampiero FRIZZI, Pomarolo (TN) (IT)

(21) Appl. No.: 15/520,316

(22) PCT Filed: Oct. 21, 2015
(86) PCT No.: PCT/IB2015/058113

§ 371 Date: Apr. 19, 2017

(30) Foreign Application Priority Data
Oct. 22, 2014 (IT) VR2014A000261

(51) Int. Cl. H01G 9/20; H01G 9/00

(52) U.S. Cl. CPC H01G 9/2059; H01G 9/2095; H01G 9/0036; H01G 9/2009; H01G 9/2031

(57) ABSTRACT

Disclosed is a photoelectrochemical cell to convert solar energy into electrical energy and to a process for the realization of the photoelectrochemical cell. The photoelectrochemical cell includes: —a first conductive external membrane; —a nanomembrane fixed to the first membrane and including titanium dioxide; —a natural pigment absorbed in the nanomembrane; —a second conductive external membrane disposed in an opposite position to the first membrane; an electrolyte, disposed between the nanomembrane and the second membrane.

The present invention refers, in general, to a photoelectrochemical cell and to a process for the realization of said photoelectrochemical cell. More particularly, the present invention refers to a photoelectrochemical cell to convert solar energy into electrical energy and to a process for the realization of said photoelectrochemical cell.

Silicon photovoltaic cells are commonly used to harness the solar energy and to convert solar energy into electrical energy.

The so-called Grätzel cells, called also DSSC or DSC or “dye-sensitized solar cell” are known. Studies are continuously evolving to develop an industrial exploitation of Grätzel cells which are photoelectrochemical cells based on the transfer of an electron from a dye excited by light.

Usually, a Grätzel cell comprises two conductive glass slides which act as electrodes and are separated by a layer of titanium dioxide, an active material that is a dye, and an electrolytic solution.

The active material is a dye that transfers electrons to the titanium dioxide owing to the absorption of a photon. Concerning the dye, anthocyanins of synthetic origin are often used. It is however also known the use of molecules extracted from the juice of blackberries and raspberries.

Following the absorption of light radiation, the anthocyanins inject the photo-excited electrons in the layer of titanium dioxide so as to create a difference of potential between the two conductive glass slides which produce electrical current if connected externally.

Thus, when the cell is in operation, solar light passes through the upper transparent electrode and hits the dye molecules usually deposited on the surface of the titanium dioxide molecules. The photons that hit the dye molecules with sufficient energy to be absorbed create an excited state in the dye molecules.

An electron can be emitted from the dye molecules directly to the conduction band of the titanium dioxide molecules. From here, the electron moves for gradient of chemical diffusion towards the upper transparent electrode acting as an anode.

The dye molecules have thus lost an electron. However, the electron is immediately recovered from the electrolytic solution typically containing iodine and potassium iodide.

The electrolytic solution is thus oxidized but recovers the transferred electrons from the lower electrode which acts as a cathode and reintroduces the electrons after these electrons have passed through the external circuit connected to the upper transparent electrode, that is the anode.

However, Grätzel cells according to the present embodiment have various problems.

First of all, Grätzel cells can be applied only on perfectly flat surfaces because the external glass slides are rigid and not flexible.

Furthermore, in order to make the two glass slides conductive, a layer of tin-antimony is applied which makes the two glass slides less transparent but this reduces the yield of the cell. Indeed, it is necessary to find the right balance between the presence of the conductive material and the transparency of the glass slide.

Another problem of the Grätzel cells according to the present embodiment is due to the use of synthetic anthocyanins as dyes since these substances make more difficult the eventual disposal of the cells in question.

Moreover, in order to fix the titanium dioxide to the glass slide acting as an anode, it is necessary to bring the glass slide at a temperature of about 300° C. but this heat risks to spoil the coloring substance or to reduce the efficiency of the coloring substance.

An aim and function of the present invention is to provide a photoelectrochemical cell to convert solar energy into electrical energy as well as a method of realization of this cell in order to overcome drawbacks and problems of photoelectrochemical cells, such as the Grätzel cells, of type known and currently implemented.

In particular, an aim of the invention is to obtain a photoelectrochemical cell to be used regardless of the form of the surface on which the cell has to be placed.

Another aim of the invention is to offer a photoelectrochemical cell having a high efficiency thanks to an optimal compromise between transparency and electrical conductivity of the outermost layers.

A further aim of the invention is to obtain a photoelectrochemical cell in which natural substances are used as much as possible in order to simplify the possible disposal of the cells.

Another aim of the invention is to offer a photoelectrochemical cell whose process of realization does not alter the nature and performance of the various components of the cell.

The above and other aims are achieved with a photoelectrochemical cell which is capable to convert solar energy into electrical energy and comprises:
a first electrically conductive external membrane;
a nanomembrane fixed to the first membrane and comprising titanium dioxide and natural pigments;
a second electrically conductive external membrane;
an electrolyte, disposed between the nanomembrane and the second membrane.

In particular, the photoelectrochemical cell is characterized by the fact that at least one of said first membrane and second membrane is made with a conductive flexible polymer film.

In this way, it is possible to obtain a flexible photoelectrochemical cell which can be placed on a surface of any form and not only on a flat surface as in the case of the cells produced according to the prior art.

In particular, at least one of said first membrane and second membrane comprises a silver-based conductive transparent deposit which guarantees the electrical conductivity of said membranes.

Advantageously, the photoelectrochemical cell according to the invention may provide that the natural pigments comprise anthocyanins, in particular anthocyanins extracted from grape skins.

In this way, the cell according to the invention is realized with natural or recyclable elements so that this cell can be easily disposed of in the event of non-use.

Besides, the electrolyte used in the cell according to the invention may be in an antifreeze gel form so that the cell can be used outdoors, even in places where the temperature goes below 0° C. In particular, the electrolyte can be based on iodide iodine and can comprise ethylene glycol.

The aims and advantages of the invention are also achieved through a process for the production of a photoelectrochemical cell, wherein the following steps are comprised:
a natural pigment is made absorb in a solution of nanocrystalline titanium dioxide in the form of monomer;
the solution of titanium dioxide and natural pigment is made photopolymerize on a first electrically conductive membrane so as to obtain a titanium dioxide nanomembrane joined to the first membrane;
the nanomembrane is fixed to the first membrane using a screen printing process;
a gel of electrolyte is spread on the nanomembrane in order to obtain a layer of electrolyte;
a second electrically conductive membrane is placed on the layer of electrolyte so as to obtain a photoelectrochemical cell comprising a first membrane, a nanomembrane, a layer of electrolyte and a second membrane, said cell being defined peripherally by a perimetric edge.

Through the process according to the invention it is possible to obtain a flexible photoelectrochemical cell whose different layers are bonded together in a stable manner and guarantee the passage of electrons through which electrical energy is originated.

Furthermore, the process according to the invention may provide that the perimetric edge of the photoelectrical cell is electrically isolated so that the first membrane and the second membrane are not directly in contact.

Advantageously, the process according to the invention may provide that the natural pigment is in the form of powder so as to be easily mixed with the titanium dioxide solution, said pigment powder being obtained by extracting anthocyanins with hydroalcoholic solution from grape skins and lyophilizing said anthocyanins.

Advantageously, the solution of titanium dioxide may be a photopolymer emulsion of titanium dioxide measuring nanopowder 20 which can be easily mixed with the pigment powder.

Besides, in order to guarantee the passage of the electrons emitted by the pigment to the titanium dioxide, the pigment powder may be mixed with the photopolymer emulsion of titanium dioxide according to a proportion of 1 to 1.

Further features and details of the invention can be better understood from the following description which is given by way of non-limiting example as well as from the annexed drawings, wherein:

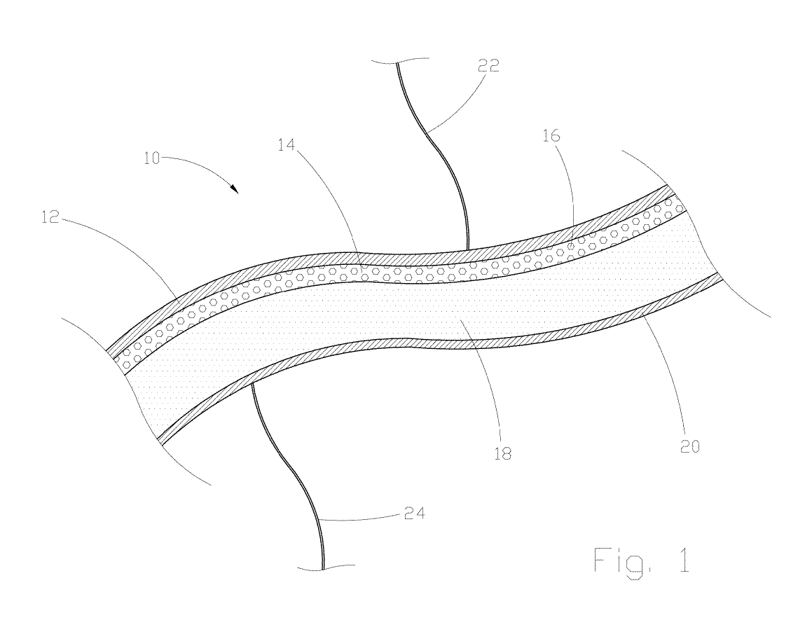

FIG. 1 is a schematic side view in section of a photoelectrochemical cell according to the invention.

With reference to the annexed FIGURE, reference number 10 denotes a photoelectrochemical cell on the whole which is capable of transforming solar energy, and more generically electromagnetic waves, into electrical energy.

In particular, the cell 10 comprises:
a first electrically conductive external membrane 12;
a nanomembrane 14 fixed to the first membrane 12 and comprising titanium dioxide;
a natural pigment 16, absorbed in the nanomembrane 14;
a second electrically conductive external membrane 20;
an electrolyte 18, disposed between the nanomembrane 14 and the second membrane 20.

According to the embodiment of the invention described here, the first membrane as well as the second membrane 20 are conductive polymer membranes and form the external structures of the cell 10.

The first membrane 12 and the second membrane 20 act as anode and cathode in the cell 10, respectively.

Both the first membrane 12 and the second membrane 20 are made by utilizing a polyester film showing an extremely thin thickness of about 175 micron and having a silver-based transparent conductive deposit.

Through the utilization of said polyester film it is possible to reach a good compromise between a low resistance and a high transparency. Besides, the so-obtained first membrane 12 and second membrane 20 are flexible so that the cell 10 is flexible. Consequently, the cell 10 can be positioned on any body, irrespective of its conformation.

The nanomembrane 14 comprising titanium dioxide is fixed to the first membrane 12. In particular, a solution of nanocrystalline titanium dioxide in form of monomer is joined to the first membrane 12 by photopolymerisation and the polymerized titanium dioxide is thus fixed to the first membrane 12 with a silkscreen printing process.

The natural pigment 16 utilized in the cell 10 according to the invention includes anthocyanins of natural origin, for example anthocyanins extracted with a hydro-alcoholic solution from grapes skins and lyophilized in order to obtain a powder from grapes skins. In this way, a pigment powder is obtained.

According to the embodiment of the invention as described here, the pigment powder is made absorb in the solution of titanium dioxide before the titanium dioxide is joined to the first membrane 12.

In particular, the pigment powder is mixed with the titanium dioxide solution which, in the present embodiment, is a photopolymer emulsion of titanium dioxide measuring nanopowder 20.

The pigment powder is mixed with the photopolymer emulsion of titanium dioxide according to a proportion of 1 to 1.

The electrolyte 18 is a iodide iodine-based gel and includes, preferably, ethylene glycol in order to prevent it from freezing if it is subjected to temperatures below 0° C.

The four sides of the cell are insulated in order to avoid short circuits and, in particular, to avoid that the first membrane 12 and the second membrane 20 come into contact undesirably.

A first electric connection 22 is fixed to the first membrane 12 and a second electric connection 24 is fixed to the second membrane 20.

The two electric connections can be fixed to a device working with electrical energy. In this case, the device is fed by the cell 10.

The operation of the cell provides that, if subjected to electromagnetic radiation, preferably within the spectrum ranging from the visible to the ultraviolet, the pigment 16, namely the anthocyanins, liberate two electrons which are captured by the titanium dioxide nanomembrane 14 and transported across the first external conductive membrane 12 acting as anode to the first electric connection 22.

The electrolyte 18 acts as a conductor of second kind, i.e. returns the electrons to the pigment so as to bring the pigment to the initial state, ready for a new cycle.

The two electrons supplied by the electrolyte 18 come from the second membrane 20 which is connected through the second electric connection 24, the device to be fed and the first electric connection 22 to the first membrane 12 from which the two same electrons have been emitted.

The process of realization of the cell 10 provides that initially, the natural pigment, i.e. the anthocyanins extracted from grapes skins, is absorbed by a solution of nanocrystalline titanium dioxide, as previously illustrated.

The solution of titanium dioxide in form of monomer is made photopolymerize on the first membrane 12 realized with a conductive, flexible Nylon® film.

Thus, a titanium dioxide nanomembrane 14 is obtained which is fixed to the first membrane 12 with a silkscreen printing process.

Then, the iodide iodine-based electrolyte 18 is spread on the titanium dioxide nanomembrane 14 including also the pigment 16.

Finally, the second membrane 20 is arranged on the layer of electrolyte 18. Also this second membrane is obtained with a transparent polyester film which has a low surface resistance and is flexible and electrically conductive.

It is evident how the photoelectrochemical cell for converting solar energy into electrical energy and the method of realization of this cell according to the invention overcome the drawbacks and problems of the photoelectrochemical cells of the prior art and currently implemented.

For the presence of external flexible membranes, the photoelectrochemical cell according to the invention may be used and arranged on any surface, even a surface curved in an irregular manner.

Besides, the photoelectrochemical cell according to the invention has a high efficiency because the transparency is ensured by the conductive polyester film which has a high transparency and conductiveness.

The photoelectrochemical cell according to the invention is realized with natural materials, possibly recyclable so as to simplify the eventual disposal of the cell.

Moreover, the process used to realize the photoelectrochemical cell according to the invention does not provide phases or procedures that alter the nature and performance of the various substances and parts forming the cell. For example, high heating procedures as in the cells produced according to prior art are not utilized.

Variants are possible, which are to be considered as included in the scope of protection; for example, the external membranes can be produced with materials different from polyester and with procedures of method that make the film face very conductive, transparent and with a low surface resistance.

Also the used anthocyanins may be obtained from other plants remaining pigments of natural origin.

1. Photoelectrochemical cell to convert solar energy into electrical energy, comprising:
a first electrically conductive external membrane;
a nanomembrane fixed to the first membrane and comprising titanium dioxide and natural pigments;
a second electrically conductive external membrane;
an electrolyte, disposed between the nanomembrane and the second membrane;
wherein at least one of said first membrane and second membrane is made with a conductive flexible polymer film.

2. Photoelectrochemical cell according to claim 1, wherein at least one of said first membrane and second membrane comprises a silver-based conductive transparent deposit.

3. Photoelectrochemical cell according to claim 1, wherein the natural pigments comprise anthocyanins extracted from the grape skins.

4. Photoelectrochemical cell according to claim 1, wherein the electrolyte is in an antifreeze gel form.

5. Photoelectrochemical cell according to claim 1, wherein the electrolyte is based on iodide iodine and comprises ethylene glycol.

6. Process for the production of a photoelectrochemical cell, wherein the following steps are comprised:
a natural pigment is made absorb in a solution of nanocrystalline titanium dioxide in the form of monomer;
the solution of titanium dioxide and natural pigment is made photopolymerize on a first electrically conductive membrane so as to obtain a titanium dioxide nanomembrane joined to the first membrane;
the nanomembrane is fixed to the first membrane using a screen printing process;
a gel of electrolyte is spread on the nanomembrane in order to obtain a layer of electrolyte;
a second electrically conductive membrane is placed on the layer of electrolyte so as to obtain a photoelectrochemical cell comprising a first membrane, a nanomembrane, a layer of electrolyte and a second membrane, said cell being defined peripherally by a perimetric edge.

7. Process according to claim 6, wherein the perimetric edge of the photoelectrical cell is electrically isolated so that the first membrane and the second membrane are not directly in contact.

8. Process according to claim 6, wherein the natural pigment is in the form of powder, obtained by extracting anthocyanins with hydroalcoholic solution from grape skins and lyophilizing said anthocyanins.

9. Process according to claim 8, wherein the solution of titanium dioxide is a photopolymer emulsion of titanium dioxide measuring nanopowder.

10. Process according to claim 9, wherein the pigment powder is mixed with the photopolymer emulsion of titanium dioxide according to a proportion of 1 to 1.

11. Photoelectrochemical cell according to claim 2, wherein the natural pigments comprise anthocyanins extracted from the grape skins.

12. Photoelectrochemical cell according to claim 11, wherein the electrolyte is in an antifreeze gel form.

13. Photoelectrochemical cell according to claim 2, wherein the electrolyte is in an antifreeze gel form.

14. Photoelectrochemical cell according to claim 3, wherein the electrolyte is in an antifreeze gel form.

15. Photoelectrochemical cell according to claim 2, wherein the electrolyte is based on iodide iodine and comprises ethylene glycol.

16. Photoelectrochemical cell according to claim 3, wherein the electrolyte is based on iodide iodine and comprises ethylene glycol.

17. Photoelectrochemical cell according to claim 4, wherein the electrolyte is based on iodide iodine and comprises ethylene glycol.

18. Process according to claim 7, wherein the natural pigment is in the form of powder, obtained by extracting anthocyanins with hydroalcoholic solution from grape skins and lyophilizing said anthocyanins.

19. Process according to claim 7, wherein the solution of titanium dioxide is a photopolymer emulsion of titanium dioxide measuring nanopowder.

20. Process according to claim 6, wherein the solution of titanium dioxide is a photopolymer emulsion of titanium dioxide measuring nanopowder.
